(19) United States
(12) Patent Application Publication
(10) Pub. No.: US 2026/0019784 A1
(43) Pub. Date: Jan. 15, 2026

(54) DYNAMICALLY CHANGING VEHICLE FUNCTION VIA CLOUD GENERATED LAMBDA

(71) Applicant: GM GLOBAL TECHNOLOGY OPERATIONS LLC, Detroit, MI (US)

(72) Inventors: Tyler Betthauser, Grosse Pointe Farms, MI (US); Gaurav Verma, Round Rock, TX (US); Jaden Yaretz, Temple, TX (US); Samuel Sidelinger, Lakeway, TX (US); Jeffrey J. Olsen, Royal Oak, MI (US); Sambasiva Velama, Round Rock, TX (US); Venugopal Devarapalli, Spring, TX (US); Abdul Bazzi, Dearborn, MI (US)

(73) Assignee: GM GLOBAL TECHNOLOGY OPERATIONS LLC, Detroit, MI (US)

(21) Appl. No.: 18/766,883

(22) Filed: Jul. 9, 2024

(51) Int. Cl. H04W 4/44; G06F 8/65

(52) U.S. Cl. CPC H04W 4/44; G06F 8/65

(57) ABSTRACT

A method for dynamically changing functions of a vehicle, or one more vehicles, via cloud generated lambda or a non-transitory computer-readable storage medium on which is recorded instructions, includes: accessing a cloud application, via other communication protocols; generation of the lambda; implementing software services on a server or other remote devices; accessing a database via the cloud application; and transferring the lambda to one or more vehicles. The software services may include other communication protocols; a configuration manager; a database manager; and a trigger manager. The software services may further include a rule manager; a data collector; an action manager; and a status handler. The methods may further include configuration parameters, implemented for the monitoring and execution of the function on the vehicle, services and applications, implemented for the monitoring and execution of the function on the vehicle, or implementing configurations, via the cloud application.

### INTRODUCTION

The present disclosure relates to dynamically changing functions via cloud generated lambda. Currently, no technologies exist for dynamically changing functions via cloud generated lambda.

### SUMMARY

A method for dynamically changing functions of a vehicle via cloud generated lambda or a non-transitory computer-readable storage medium on which is recorded instructions, including: accessing a cloud application, via other communication protocols; generation of the lambda; implementing software services on a server or other remote devices; accessing a database via the cloud application; and transferring the lambda to one or more vehicles. The software services may include, other communication protocols; a configuration manager; a database manager; and a trigger manager.

The software services may further include, a rule manager; a data collector; an action manager; and a status handler. The methods may further include configuration parameters, implemented for the monitoring and execution of the function on the vehicle, services and applications, implemented for the monitoring and execution of the function on the vehicle, or implementing configurations, via the cloud application.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic view of a vehicle and cellular, or other, communication system which may be linked with one or more clouds.

FIG. 2 is a schematic flow chart of a method or methods for dynamically changing functions via cloud generated lambda, in concert with FIG. 3.

FIG. 3 is a schematic flow chart of a method or methods for dynamically changing functions via cloud generated lambda, in concert with FIG. 2.

FIG. 4 is a schematic representation of box 134 in FIG. 3.

### DETAILED DESCRIPTION

Referring to the drawings, like reference numbers refer to similar components, wherever possible. In general, a separately excited machine is one where the field winding or coil is energized by a separate or external source. The flux produced by the poles depends upon the field current with the unsaturated region of magnetic material of the poles—i.e., flux is directly proportional to the field current—but in the saturated region, the flux remains constant.

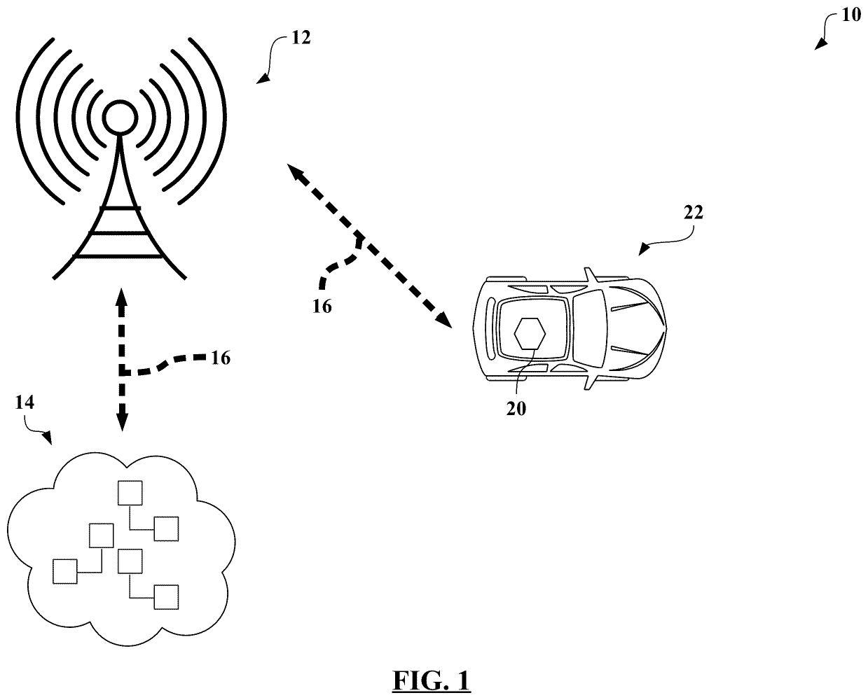

FIG. 1 schematically illustrates a connectivity network or connectivity system 10. The connectivity system 10 includes numerous components, only some of which are listed, and/or shown, herein.

A remote or cellular communications system, or cellular network 12, which may be representative of many types of communications protocols, including, without limitation: cellular, satellite, Wi-Fi, Bluetooth, ultra-wideband (UWB) or other communications recognizable to those having ordinary skill in the art. UWB is a radio-based communication technology for short-range use and fast and stable transmission of data.

A centralized location 14 is shown highly schematically, but may be representative of many different structures, clouds, servers, or elements, as will be recognized by skilled artisans. The centralized location 14 represents systems that communicate with some or all of the other systems and/or objects described herein. The centralized location 14 includes numerous controllers 20. Additionally, the centralized location 14 may be a back office (BO) of the manufacturer of the vehicles.

Several transfer protocols or transfers 16 are schematically illustrated. These transfers 16 may include, without limitation: cellular, Wi-Fi, wired networks, over-the-air (OTA), other transport protocols, including machine to machine (M2M), or other telematics equipment, or other systems recognizable by those having ordinary skill in the art. M2M systems use point-to-point communications between machines, sensors, and hardware over cellular, Wi-Fi, or wired networks.

The drawings and figures presented herein are diagrams, are not to scale, and are provided purely for descriptive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting the claims or the description.

The term vehicle is broadly applied to any moving platform. Vehicles into which the disclosure may be incorporated include, for example and without limitation: passenger or freight vehicles; autonomous driving vehicles; industrial, construction, and mining equipment; and various types of aircraft.

All numerical values of parameters (e.g., of quantities or conditions) in this specification, including the appended claims, are to be understood as being modified in all instances by the term “about,” whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

A generalized control system, computing system, or controller 20 is operatively in communication with relevant components of all systems, and recognizable by those having ordinary skill in the art. The controller 20 includes, for example and without limitation, a non-generalized, electronic control device having a preprogrammed digital computer or processor, a memory, storage, or non-transitory computer-readable storage medium used to store data such as control logic, instructions, lookup tables, etc., and a plurality of input/output peripherals, ports, or other communication protocols.

Furthermore, controller 20 may include, or be in communication with, a plurality of sensors. The controller 20 is configured to execute or implement all control logic or instructions described herein and may be communicating with any sensors described herein or recognizable by skilled artisans.

Any of the methods described herein may be executed by one or more controllers 20. Note that this algorithm may run on, generally, less expensive controllers 20. A vehicle 22 is shown in FIG. 1, but there may be other vehicles 22 that are not shown.

Essentially the process includes, without limitation: First, a configuration is created (basically, a message) that defines a trigger, rule, and action. Second, the trigger is some data to monitor in vehicle(s) 22. Third, there is a rule, which may be an algorithm, that determines when an action occurs. This may include transferring one or more cloud-based lambdas to one or more vehicles 22. This may include, without limitation, defining a concept of layers: a distribution mechanism for libraries, custom runtimes to support other languages, and other dependencies, alternatively, this may enable open binding extensions so that the community can create new types of bindings and bring them into function applications.

Fourth, the action implements a function to call or a process to execute-this may be a model where the action will be known or unknown to whomever has created the cloud generated, or cloud-based, lambda. This may create the rule, which may be a heuristic or data-driven model—note that this may be different types of models and models with multiple outputs—the cloud generated lambda may be fine-tuned to generate the stochastic model and there may be different actions that may occur based on the lambda. This lambda may be defined, without limitation, lambda is a function without a name, or an anonymous function, and/or a small piece of executable code, that can be passed around as if it were a variable. In this case, the loop, or the configuration, is the lambda in these systems.

Cloud lambda functions may be serverless compute functions that run code on high availability infrastructure and are fully managed by one or more cloud providers. This, generally, allows developers to focus on writing code without worrying about infrastructure management, such as server provisioning, operating system maintenance, and capacity planning.

Generating the cloud generated lambda may include numerous steps recognizable to those having ordinary skill in the art. The function may be a pre-determined function, a set of a few pre-determined functions, or a function that is completely determined by the algorithm itself.

In general, lambda runs some, or all, code on high availability computing infrastructure and performs all the administration of your computing resources. This includes server and operating system maintenance, capacity provisioning and automatic scaling, code and security patch deployment, and code monitoring and logging. Cloud lambda functions may be serverless compute functions that run code on high availability infrastructure and are fully managed by a cloud provider. This, generally, allows developers to focus on writing code without worrying about infrastructure management, such as server provisioning, operating system maintenance, and capacity planning.

This, generally, creates the cloud generated lambda for use by one or more vehicles 22, which may be an action known or taken by the controller 20, or other structures. Non-deterministic model means, generally, likely to have a different result every time, so that it is not possible to guess what will happen, such that a complex system may be unstable and/or dynamic.

This may, generally, create functions, self-contained applications written in one of the supported languages and runtimes, and upload them to the lambda, which executes those functions in an efficient and flexible manner. The lambda functions can perform any kind of computing task, from serving web pages and processing streams of data to calling APIs (Application Programming Interfaces) and integrating with other services. The concept of serverless computing refers to not needing to maintain your own servers to run these functions.

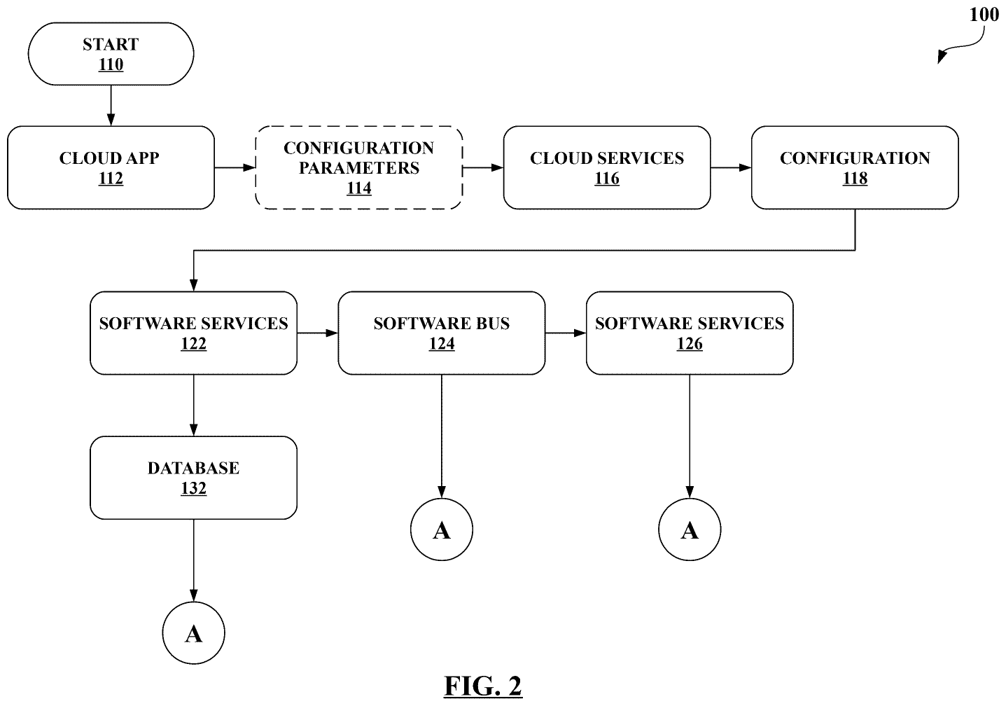

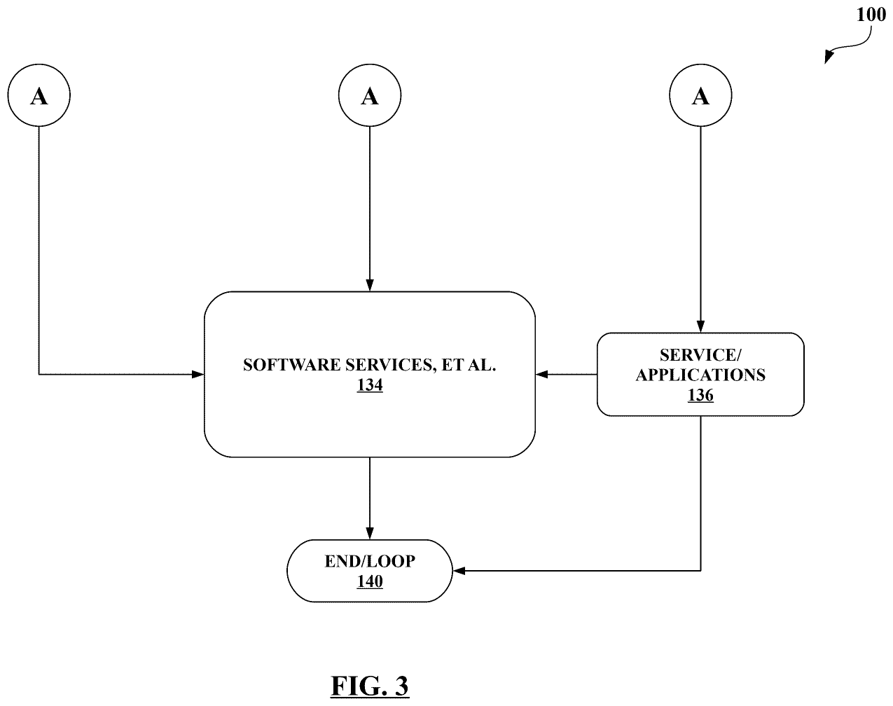

FIGS. 2 and 3 are a schematic flow chart diagram of a method 100, or methods, for dynamically changing functions via cloud generated lambda in one or more vehicles 22, note that the method 100 may move back and forth between FIGS. 2 and 3. One or more of the methods described herein may be executed by the controller 20, including the non-transitory computer-readable storage medium, or other structures or equipment recognizable to skilled artisans. All steps described herein may be optional, in addition to those explicitly stated as such, and all steps described may be reordered or removed.

Any of the methods described herein may store the data in the centralized location 14 via the connectivity system 10. The methods 100 described herein may be used to change vehicle 22 functions on the fly.

Step 110: START. At step 110, method 100 initializes or starts. Method 100 may begin operation when called upon by one or more controllers 20, may be constantly running, or may be looping iteratively.

Step 112: CLOUD APPLICATION. At step 112, method 100 implements one or more cloud applications, such as those in the centralized location 14, or other clouds, as will be recognized by those having ordinary skill in the art. Note that accessing the cloud applications may include one or more steps recognized by those having ordinary skill in the art. Cloud applications are software that users access primarily through the internet, meaning at least some of it is managed by a server and not users' local machines. Cloud-native application development strategies help development teams design apps with consistent experiences.

Optional Step 114: CONFIGURATION PARAMETERS. At optional step 114, method 100 may determine configuration parameters. This may include, without limitation, UFL (Unified Framework Layer) service for managing loops, rules, and triggers within the vehicle ecosystem. The UFL service enables automated actions and data collection based on defined rules and conditions within the vehicle.

This may include, without limitation, priority level of the loop used by the UFL service to manage resources and the logical expressions that define the rule. Controller Area Network (CAN) signal may also be used in addition to name of the broadcast to be monitored. This may include, without limitation, defining the UDS (Unified Diagnostic Services) data structure used as a trigger and may defining criteria for filtering log messages used as triggers. This may further include, without limitation: INVALID_SERVICE; DIAGNOSTIC_CONTROL_SESSION; ECU_RESET; SECURITY_ACCESS; COMMUNICATION_CONTROL; CONTROL_DTC; TESTER_PRESENT; READ_DATA_BY_ID; DYNAMICALLY_DEFINE_ID; WRITE_DATA_BY_IDENTIFIER; CLEAR_DIAGNOSTIC_INFORMATION; READ_DTC_INFORMATION; INPUT_OUTPUT_CONTROL; and/or ROUTINE_CONTROL.

This may further include, without limitation: defines a mitigation action, including the method, endpoint, and values, and defines the data to be collected when a rule is triggered. For example, and without limitation, in this example, a loop named Battery Monitoring Loop (BLM) is defined to monitor battery levels and trigger an alert when the battery level drops below 20%.

Step 116: CLOUD SERVICES. At step 116, method 100 implements various cloud services, such as those in the centralized location 14, or other clouds, as will be recognized by those having ordinary skill in the art.

Step 118: CONFIGURATION. At step 118, method 100 sends the configuration, likely through the cellular network 12 and via one or more of the transfer protocols or transfers 16. This may include transferring the cloud-based lambda to one or more vehicles 22.

Step 122: SOFTWARE SERVICES. At step 122, method 100 communicates with the software services. This may include a pub/sub, which lets you create systems of event producers and consumers, called publishers and subscribers. This may include other patterns of communication, without limitation: request-reply, point-to-point, message queue, and/or broadcast.

Software services—or software as a service (SaaS)—is a form of cloud computing in which the provider offers the use of application software to a client and manages all the physical and software resources used by the application. The distinguishing feature of SaaS compared to other software delivery models is that it separates, “the possession and ownership of software from its use.”

SaaS is usually accessed via a web application. Unlike most self-hosted software products, only one version of the software exists and only one operating system and configuration are supported, but there may be other systems and configurations supported. Some SaaS providers offer free services to consumers that are funded by means such as advertising, affiliate marketing, or selling consumer data. SaaS products are typically accessed via a web browser as a publicly available web application.

Step 124: SOFTWARE BUS. At step 124, method 100 communicates with one or more software buses, or endpoints, or services, or other communication protocols that would be recognizable by those having ordinary skill in the art.

Step 126: SOFTWARE SERVICES. At step 126, method 100 communicates with the software services. This may include remote procedure call (RPC) protocol, which is generally used to communicate between processes on different workstations. However, RPC may also work for communication between different processes on the same workstation. Implementing one or more software services on a server or other remote devices will be recognized by those having ordinary skill in the art.

Step 132: DATABASE. At step 132, method 100 communicates with one or more databases. This may include java database connectivity (JDBC). Note that any of the communication protocols discussed herein may be used with any of the methods discussed herein. Including, without limitation, JDBC, pub/sub, RPC, or others recognizable to those having ordinary skill in the art. This may include accessing the database via the cloud application, including, without limitation, the centralized location 14.

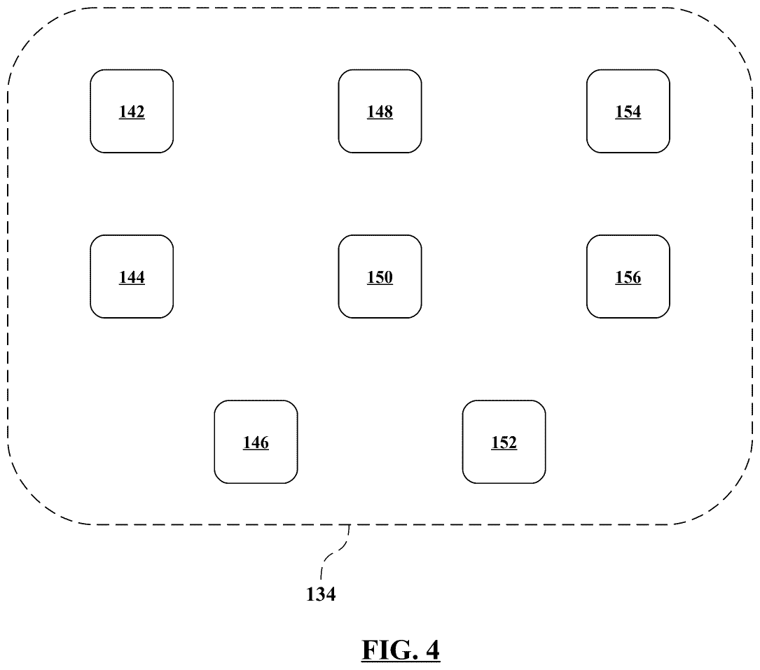

Step 134: SOFTWARE SERVICES, ET AL. At step 134, method 100 includes numerous, or performs, software services, some of which may be shown in FIG. 4.

Step 136: SERVICE AND/OR APPLICATIONS. At step 136, method 100 services and/or applications. Note that these may be communicated via broadcast systems or method calls, or any others recognizable to those having ordinary skill in the art.

Step 140: END/LOOP. At step 140, the method 100 ends or loops. Ending/looping may include proceeding back to start step 110 or waiting until called upon to run again, such as by one of the controllers 20 or another portion of the connectivity system 10.

FIG. 4 is a schematic representation of step 134 some of which are shown in box 134 in FIG. 3. This includes, without limitation: 142 Bus Monitor, or other communication protocols; 144 Configuration Manager; 146 Database Manager; 148 Trigger Manager; 150 Rule Manager; 152 Data Collector; 154 Action Manager; and/or 156 Status Handler. Note that other software services, et al., may be used, including several that will be recognized by those having ordinary skill in the art.

It offers the potential for more cloud-based services, faster software development, and new opportunities to increase customer loyalty. Note that these methods may reduce cycle time for problem solving and remediation and may empower individual business units to improve customer experiences. Additionally, these methods allow business units to not rely on the software org to improve customer experiences and drive value, and may the service be easy to work with and can have people trained to use it very quickly.

Additionally, these methods enable reduced costs in warranty and development itself and can deploy new, novel functionality to certain vehicles before devoting many hours of labor and development dollars by being creative with the configurations-all through configuration of the cloud generated lambda. Then, if they see the improvement, if successful, the final version can be deployed to the fleet later. The configuration is further able to command the service to perform complex function calls using an algorithm to existing interfaces already provided by the system itself.

Not only can users create configurations that are self-contained-meaning they perform only one or a few functions-but they can also have their functions interact with other functions. For example, and without limitation, Lambda A utilizes an output of Lambda B to invoke a function from Lambda A.

The detailed description and the drawings or figures are supportive and descriptive of the subject matter herein. While some of the best modes and other embodiments have been described in detail, various alternative designs, embodiments, and configurations exist.

Furthermore, any examples shown in the drawings, or the characteristics of various examples mentioned in the present description, are not necessarily to be understood as examples independent of each other. Rather, it is possible that each of the characteristics described in one of the examples of an embodiment can be combined with one or a plurality of other desired characteristics from other examples, resulting in other examples not described in words or by reference to the drawings. Accordingly, such other examples fall within the framework of the scope of the appended claims.

1. A method for dynamically changing functions of one or more vehicles via cloud generated lambda, comprising:
accessing a cloud application, via one or more communication protocols;
generating the cloud generated lambda, such as via the cloud application;
implementing software services on a server or other remote devices;
accessing a database via the cloud application; and
transferring the cloud generated lambda to one or more vehicles.

2. The method for dynamically changing functions of one or more vehicles via cloud generated lambda claim 1, wherein the software services include:
the one or more communication protocols;
a configuration manager;
a database manager; and
a trigger manager.

3. The method for dynamically changing functions of one or more vehicles via cloud generated lambda claim 2, wherein the software services include:
a rule manager;
a data collector;
an action manager; and
a status handler.

4. The method for dynamically changing functions of one or more vehicles via cloud generated lambda claim 3, further comprising:
implementing configuration parameters to thereby monitor and execute the functions of one or more vehicles.

5. The method for dynamically changing functions of one or more vehicles via cloud generated lambda claim 4, further comprising:
implementing services and applications, to thereby monitor and execute the functions of one or more vehicles.

6. The method for dynamically changing functions of one or more vehicles via cloud generated lambda claim 5, further comprising:
implementing configurations of one or more vehicles, via the cloud application.

7. The method for dynamically changing functions of one or more vehicles via cloud generated lambda claim 1, further comprising:
implementing configuration parameters to monitor and execute the functions of one or more vehicles.

8. The method for dynamically changing functions of one or more vehicles via cloud generated lambda claim 7, further comprising:
implementing services and applications, to monitor and execute the functions of one or more vehicles.

9. The method for dynamically changing functions of one or more vehicles via cloud generated lambda claim 8, further comprising:
implementing configurations for one or more vehicles, via the cloud application.

10. The method for dynamically changing functions of one or more vehicles via cloud generated lambda claim 1, further comprising:
implementing services and applications, to monitor and execute the functions of one or more vehicles; and
implementing configurations for one or more vehicles, via the cloud application.

11. A non-transitory computer-readable storage medium on which is recorded instructions, wherein execution of the instructions by a processor causes the processor to:
dynamically change functions via cloud generated lambda of the one or more vehicles;
accessing a cloud application via the one or more vehicles;
implementing software services via the monitoring and execution of the function on the one or more vehicles;
accessing a database via the cloud application;
implementing configuration parameters via the cloud application;
implementing services and applications via the cloud application;
creating a trigger, the trigger including data from the one or more vehicles;
creating a rule as a heuristic or data-driven model or non-deterministic model; and
creating an action, which implements a function to call or a process to execute.

12. The non-transitory computer-readable storage medium on which is recorded instructions, wherein execution of the instructions by a processor causes the processor to, of claim 11, wherein the software services include:
one or more communication protocols;
a configuration manager;
a database manager; and
a trigger manager.

13. The non-transitory computer-readable storage medium on which is recorded instructions, wherein execution of the instructions by a processor causes the processor to, of claim 12:
implementing services and applications to monitor and execute the functions of one or more vehicles.

14. The non-transitory computer-readable storage medium on which is recorded instructions, wherein execution of the instructions by a processor causes the processor to, of claim 13:
implementing configuration parameters to thereby monitor and execute the functions of one or more vehicles.

15. The non-transitory computer-readable storage medium on which is recorded instructions, wherein execution of the instructions by a processor causes the processor to, of claim 14, wherein the software services include:
a rule manager;
a data collector;
an action manager; and
a status handler.

16. The non-transitory computer-readable storage medium on which is recorded instructions, wherein execution of the instructions by a processor causes the processor to, of claim 11:
implementing services and applications to monitor and execute the functions of one or more vehicles.

17. A method for dynamically changing functions of one or more vehicles via cloud generated lambda, comprising:
accessing a cloud application, via other communication protocols;
generating the cloud generated lambda;
implementing software services on a server or other remote device;
accessing a database via the cloud application; and
transferring the cloud generated lambda to one or more vehicles;
wherein the software services include:
other communication protocols;
a configuration manager;
a database manager;
a trigger manager.
a rule manager;
a data collector;
an action manager; and
a status handler.

18. The method for dynamically changing functions of one or more vehicles via cloud generated lambda claim 17, further comprising:
implementing configuration parameters for the monitoring and execution of the functions on one or more vehicles; or
implementing services and applications for the monitoring and execution of the functions on one or more vehicles.

19. The method for dynamically changing functions of one or more vehicles via cloud generated lambda claim 18, further comprising:
implementing configurations of one or more vehicles, via the cloud application.

20. The method for dynamically changing functions of one or more vehicles via cloud generated lambda claim 17, further comprising:
implementing configurations of one or more vehicles, via the cloud application.
